(19) United States
(12) Patent Application Publication
(10) Pub. No.: US 2010/0150291 A1
(43) Pub. Date: Jun. 17, 2010

(54) BLANKET USING LITHIUM NANOFLUID AND FUSION REACTOR HAVING THE SAME

(76) Inventors: Ki Sok Jung, Daejeon Metropolitan City (KR); Bong Guen Hong, Daejeon Metropolitan City (KR); Dong Won Lee, Daejeon Metropolitan City (KR)

Correspondence Address: HAYES SOLOWAY P.C., 3450 E. SUNRISE DRIVE, SUITE 140, TUCSON, AZ, 85718, US

(21) Appl. No.: 12/633,476

(22) Filed: Dec. 8, 2009

(30) Foreign Application Priority Data
Dec. 15, 2008 (KR) 10-2008-0127110

(51) Int. Cl. G21B 1/13

(52) U.S. Cl. 376/150

(57) ABSTRACT

Disclosed are a blanket using lithium nanofluid and a fusion reactor including the same. The blanket multiplies a fuel of the fusion reactor using lithium nanofluid, and applies the lithium nanofluid to a cooling process of cooling the blanket. In this instance, the lithium nanofluid is preferably obtained by dispersing a metal or a metal oxide nano-particle in liquid lithium. Also, the fusion reactor includes a blanket to accommodate plasma to generate a thermal energy due to a reaction of the plasma, a fuel feeding unit to feed a fuel required for the reaction of the plasma, the fuel feeding unit being connected to the blanket, a coolant feeding unit to feed a coolant, and a coolant transfer unit to transfer the coolant by connecting the blanket with the coolant feeding unit.

### CROSS-REFERENCE TO RELATED APPLICATION

This application claims the benefit of Korean Patent Application No. 10-2008-0127110, filed on Dec. 15, 2008, in the Korean Intellectual Property Office, the disclosure of which is incorporated herein by reference.

### BACKGROUND

1. Field

Exemplary embodiments relate to a blanket using lithium nanofluid and a fusion reactor including the same, and more particularly, to a blanket using lithium nanofluid and a fusion reactor including the same that may remarkably reduce a reaction reactivity with water or air to improve stability and reliability, obtain economical effects due to feasibility of the fusion reactor, accident prevention, and the like, and dramatically improve stability without changing an existing structure of a fusion reactor.

2. Description of the Related Art

For transition to an era of green energy such as using a nuclear energy, etc., from the current fossil-fuel dependant era, various studies have been actively made. Of these, an interest in a study for creating non-polluting and renewable energy using nuclear fusion may increase. In other words, a method of carrying out a plasma reaction using deuterium of hydrogen isotopes or tritium in a fusion reactor has been developed; however, the method may encounter many difficulties when realized.

In the fusion reactor, a blanket may be an important component performing an energy conversion, such as a nuclear fuel rod in a nuclear reactor. As a fuel of the fusion reactor, natural or artificial tritium may be used. In this instance, the blanket may improve multiplication of the tritium due to a limitation in an amount of the blanket. As a material used for the breeding, a lithium metal may be basically used, and various materials such as a liquid type, a solid type, a pure type, a compound type, and the like may be used. Also, a coolant of cooling the blanket may vary, and, water may be extensively used as the coolant.

FIG. 1 illustrates an example of a structural material, a breeder, and a coolant depending on a design example according to a conventional art.

However, lithium may be an alkali metal, and have a high reactivity with water, and thereby a high chance of a dangerous explosion may exist. Particularly, from a concept such as an International Thermonuclear Experimental Reactor (ITER) or a demo plant, a possibility of an accident occurring due to a reaction between a lithium-based multiplying agent and a water-based coolant may be relatively high, and thus the danger of explosion of the lithium-water reaction has been raised as one of important issues in terms of stability of the fusion reactor.

Accordingly, there is an urgent need for a technology of safely manufacturing the lithium, which may solve the aforementioned problems to improve the stability of the fusion reactor.

### SUMMARY

An aspect of exemplary embodiments provides a blanket using lithium nanofluid and a fusion reactor including the same, which may remarkably reduce reactivity with water to improve stability and reliability. In this instance, the lithium nanofluid may be used to breed the tritium and cool the fusion reactor as a coolant.

An aspect of exemplary embodiments also provides a blanket using lithium nanofluid and a fusion reactor including the same, which may obtain economical effects due to feasibility of the fusion reactor, accident prevention, and the like.

An aspect of exemplary embodiments also provides a blanket using lithium nanofluid and a fusion reactor including the same, which may dramatically improve stability without changing an existing structure of the fusion reactor.

According to an aspect of exemplary embodiments, there is provided a blanket performing an energy conversion in a fusion reactor, which multiplies a fuel of the fusion reactor using lithium nanofluid, and applies the lithium nanofluid to a cooling process of cooling the blanket. In this instance, the lithium nanofluid may be obtained by dispersing a metal or a metal oxide nano-particle into liquid lithium.

According to another aspect of exemplary embodiments, there is provided a fusion reactor using lithium nanofluid, the fusion reactor including: a blanket to accommodate plasma to generate a thermal energy due to a reaction of the plasma; a fuel feeding unit to feed a fuel required for the reaction of the plasma, the fuel feeding unit being connected to the blanket; a coolant feeding unit to feed a coolant; and a coolant transfer unit to transfer the coolant by connecting the blanket with the coolant feeding unit. In this instance, the lithium nanofluid may be used to multiply or cool the fuel.

According to still another aspect of exemplary embodiments, there is provided a fusion reactor using lithium nanofluid, which performs an energy conversion using fusion reaction, and utilizes the lithium nanofluid as a coolant. In this instance, the lithium nanofluid may be used to multiply a fuel of the fusion reactor.

Also, according to exemplary embodiments, a multiplying agent and a coolant may be the same. That is, in a fusion reactor performing an energy conversion using a fusion reaction, the multiplying agent used to multiply a fuel of the fusion reactor may be utilized as the coolant. As these multiplying agent and coolant, the lithium nanofluid may be preferably used. In this instance, the lithium nanofluid may be obtained by dispersing a metal or a metal oxide nano-particle in liquid lithium.

### EFFECT

According to exemplary embodiments of the present invention, it may be possible to remarkably reduce a reaction with water to improve stability and reliability.

Also, according to exemplary embodiments, it may be possible to obtain economical effects due to feasibility of the fusion reactor, accident prevention, and the like.

Also, it may be possible to dramatically improve stability without changing an existing structure of the fusion reactor.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 illustrates an example of a structural material, a breeder, and a coolant depending on a design example according to a conventional art;

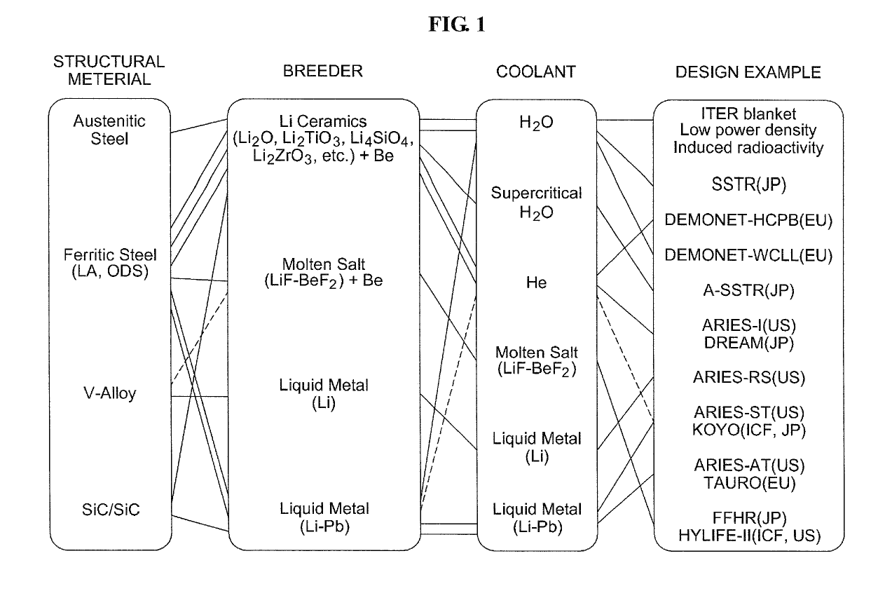

FIG. 2 is a schematic cross-sectional diagram illustrating a fusion reactor according to exemplary embodiments of the present invention;

FIG. 3 is a schematic diagram illustrating a process in which a heat is transmitted from a plasma core to a coolant according to exemplary embodiments of the present invention; and

FIG. 4 is a graph illustrating hourly temperature differences with respect to a mixed reaction of lithium and water with nano-particles and without nano-particles.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

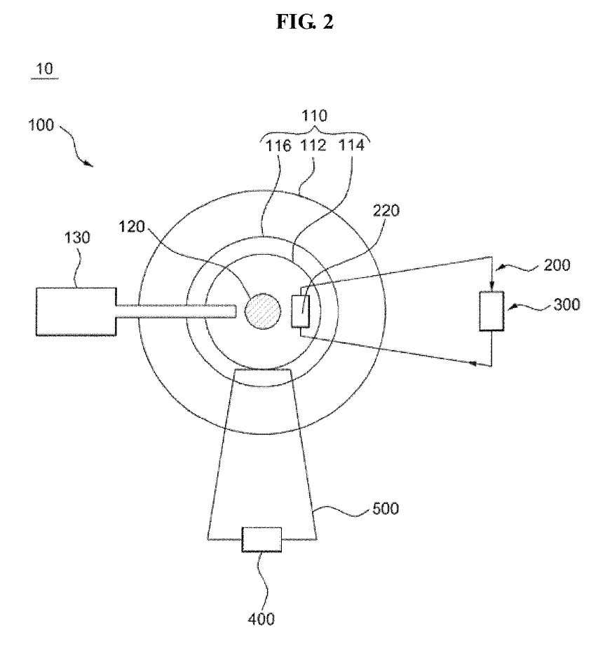

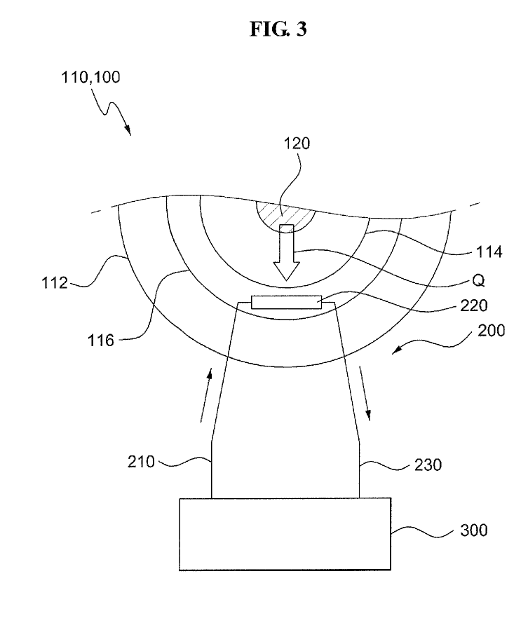

Hereinafter, a configuration of a fusion reactor according to exemplary embodiments of the present invention will be described in detail with reference to FIGS. 2 and 3. FIG. 2 is a schematic cross-sectional diagram illustrating a fusion reactor 10 according to exemplary embodiments of the present invention, and FIG. 3 is a schematic diagram illustrating a process in which a heat is transmitted from a plasma core to a coolant according to exemplary embodiments of the present invention. According to the present exemplary embodiments, the fusion reactor 10 includes a heat generation unit 100, a coolant transfer unit 200, a coolant feeding unit 300, and a fuel feeding unit having a fuel circulation unit 400 and a fuel transfer unit 500.

The heat generation unit 100 may provide a space where a plasma reaction is created, and may include a reaction vessel 110, a plasma core 120, and a plasma heating unit 130.

The reaction vessel 110 may include a vacuum vessel portion 112 formed on an outside of the plasma core 120, and a blanket 116 where a heat is created. The plasma core 120 may be a portion acting as a heart of the fusion reactor 10 according to the present invention. The plasma core 120 may be fed with a D-T fuel (deuterium (D) and tritium (T)) from the fuel circulation unit 400 and a fuel/coolant transfer unit 600, and a plasma may be generated by the plasma heating unit 130. Also, in the plasma core 120, the generated plasma may be heated and sealed to reach a self-ignition condition, and thereby an enormous energy may be created by a continuously performed fusion reaction.

An energy created by the plasma reaction in the plasma core 120 may be emitted as alpha particles and a kinetic energy of neutrons, that is, products of the plasma reaction, and electromagnetic radiations. Of these, the alpha particles having an electric charge may remain within the plasma core 120, since the plasma is sealed by a magnetic field, to thereby continue to maintain the plasma in an ultra-high temperature state. Otherwise, the alpha particles may be exhausted through an outlet referred to as a diverter after the alpha particles are used. Particularly, a maximum heat load may be generated in the diverter. The electromagnetic radiations and neutrons may freely escape from the plasma core 120 to be absorbed in the blanket 114.

In addition, in the blanket 114, a coolant for removing a heat energy converted from the kinetic energy of the neutrons may flow. Also, the blanket 114 may contain lithium (Li), and may generate a tritium through a nuclear reaction between the Li and the neutrons. The blanket 114 may feed the generated tritium into the fuel feeding unit (not illustrated).

The blanket 114 may maintain a significantly high temperature due to the plasma reaction, and thereby, it may be required to continue to cool the blanket 114 in order to stably and continuously perform the plasma reaction. In this instance, a cooling process of cooling the blanket 114 may be performed using the coolant.

The coolant feeding unit 300 may feed the coolant into the blanket 114.

The coolant transfer unit 200 may be provided between the heat generation unit 100 and the coolant feeding unit 300, and may absorb a heat generated by the plasma reaction performed in the plasma core 120, and transmit the absorbed heat to the outside, thereby cooling the plasma core 120.

More specifically, the coolant transfer unit 200 may include a first transfer unit 210, a heat transmission unit 220, and a second transfer unit 230.

The first transfer unit 210 may connect the coolant feeding unit 300 with the heat transmission unit 220 to transfer the coolant having a relatively low temperature to the heat transmission unit 220.

The heat transmission unit 220 may be formed to face the plasma core 120, and may contact the blanket 114 to exchange a heat (Q) between the coolant and the blanket 114. The heat transmission unit 220 may preferably have a larger surface area being in close contact with the blanket 114 so as to obtain high heat-transmission effects. Here, the heat transmission unit 220 will be described in further detail with reference to FIG. 3.

The second transfer unit 230 may be provided between the heat transmission unit 220 and the coolant feeding unit 300, and transfer, to the coolant feeding unit 300, the heat (Q) transmitted to the coolant of the heat transmission unit 220.

The fusion reactor 10 may further include a pressurization unit (not illustrated) used to pressurize the coolant flowing in an interior of the coolant transfer unit 200. For example, the pressurization unit may be provided on a path of the coolant transfer unit 200 to pressurize the coolant flowing to the heat transmission unit 220.

According to the present exemplary embodiment, nanofluid obtained by dispersing nano-particles in liquid lithium may be used, thereby significantly reducing reactivity with water, and reducing thermal conductivity. That is, with an increase in a temperature, the reactivity with water may be additionally reduced due to an effective heat removal using the nano-particles having a more excellent thermal conductivity when a greater reactivity is exhibited. That is, it may be possible for existing lithium used for multiplication to be of a nanofluid type, and thereby may be used as the coolant.

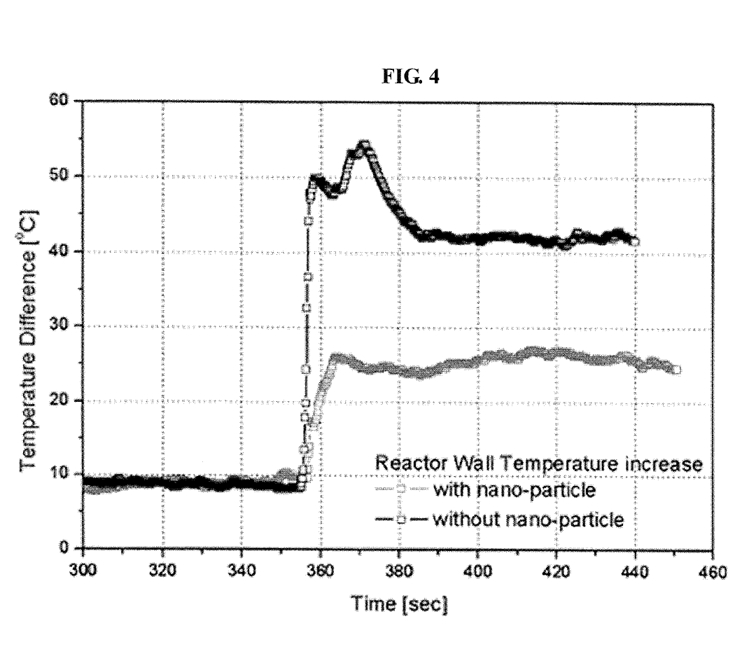

FIG. 4 is a graph illustrating hourly temperature differences with respect to a mixed reaction of lithium and water with nano-particles and without nano-particles. As illustrated in FIG. 4, when the reactivity with water is not controlled due to the lithium not containing the nano-particles, it may be found that a temperature difference of 40 degrees or more is generated based on results obtained by measuring a temperature of a reactor wall.

This reaction may be generated by the following chemical equation,

2Li+2H₂O→2LiOH+H₂↑.

However, in a case of the lithium containing the nano-particles, it may be found that the temperature difference of the reactor wall of about 20 to 30 degrees is generated.

That is, the reactivity with water may be additionally reduced over time due to an effective heat removal using the nano-particles having a more excellent thermal conductivity when a greater reactivity is exhibited. Accordingly, it may be empirically found that the reactivity with water serving as the coolant may be significantly reduced by utilizing the nanofluid obtained by dispersing the nano-particles in the liquid lithium.

Fusion Technologies of South Korea may approach a world level by participating in an International Thermonuclear Experimental Reactor (ITER) project. The ITER project may have goals such that by the year 2015, a thermal power of 500,000 kW corresponding to ⅙ of a Korean standard nuclear power plant, and a ratio (Q) of an input energy to output energy of 10 is to be realized. After the United States and the Soviet Union first started the ITER, the EU, Japan, South Korea, China, and India also participated in the ITER. The ITER may increase the competition of countries for a part of the fusion technology where value-added is able to be created, which is different from reserving rights for the fusion technology in a cooperative manner with other countries. Thus, when ensuring our own technologies in a design of a blanket associated with tritium multiplication, as one of the part of the fusion technology where value-added is able to be created, significant economic benefits may be obtained while developing a demonstration plant (demo plant) that is one step ahead of other countries.

According to the present invention, a probability of an accident caused by the contact of the lithium and water may be significantly reduced by utilizing the nanofluid obtained by dispersing the nano-particles in the liquid lithium, thereby contributing to safer fusion technology and more to national industries and economies.

Here, the lithium nanofluid may be exemplarily described; however, the present invention is not limited thereto. Thus, according to the present invention, an element used for multiplication and an element used for cooling may be the same.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A blanket performing an energy conversion in a fusion reactor, which multiplies a fuel of the fusion reactor using lithium nanofluid, and applies the lithium nanofluid to a cooling process of cooling the blanket.

2. The blanket of claim 1, wherein the lithium nanofluid is obtained by dispersing a metal or a metal oxide nano-particle in liquid lithium.

3. A fusion reactor using lithium nanofluid, the fusion reactor comprising:
a blanket to accommodate plasma to generate a thermal energy due to a reaction of the plasma;
a fuel feeding unit to feed a fuel required for the reaction of the plasma, the fuel feeding unit being connected to the blanket;
a coolant feeding unit to feed a coolant; and
a coolant transfer unit to transfer the coolant by connecting the blanket with the coolant feeding unit, wherein
the lithium nanofluid is used to multiply or cool the fuel.

4. The fusion reactor of claim 3, wherein the lithium nanofluid is obtained by dispersing a metal or a metal oxide nano-particle in liquid lithium, thereby reducing reactivity with water being used to cool the blanket.

5. A fusion reactor using lithium nanofluid, which performs an energy conversion using fusion reaction, and utilizes the lithium nanofluid as a coolant, the lithium nanofluid being used to multiply a fuel of the fusion reactor.

6. A fusion reactor using lithium nanofluid, which performs an energy conversion using fusion reaction, and utilizes a multiplying agent as a coolant, the multiplying agent being used to multiply a fuel of the fusion reactor.

7. The fusion reactor of claim 6, wherein the multiplying agent and the coolant are the lithium nanofluid.

8. The fusion reactor of claim 7, wherein the lithium nanofluid is obtained by dispersing a metal or a metal oxide nano-particle in liquid lithium.
